(19) United States
(12) Patent Application Publication
(10) Pub. No.: US 2021/0405814 A1
(43) Pub. Date: Dec. 30, 2021

(54) TOUCH ELECTRODE, TOUCH PANEL, AND DISPLAY DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventors: Bo LI, Wuhan, Hubei (CN); Yimei ZHANG, Wuhan, Hubei (CN)

(21) Appl. No.: 16/642,286

(22) PCT Filed: Dec. 27, 2019
(86) PCT No.: PCT/CN2019/129281

§ 371 Date: Feb. 26, 2020

(30) Foreign Application Priority Data
Jul. 25, 2019 (CN) 201910675281.3

(51) Int. Cl. G06F 3/044

(52) U.S. Cl. CPC G06F 3/0446; G06F 2203/04111; G06F 3/0448

(57) ABSTRACT

The present application proposes a touch electrode, a touch panel, and a display device. The touch electrode includes a plurality of first sub-electrodes, wherein each two of the first sub-electrodes are electrically connected to each other by a connecting body; a plurality of second sub-electrodes, wherein each two of the second sub-electrodes are directly electrically connected to each other; wherein the plurality of first sub-electrodes and the plurality of second sub-electrodes are staggered with each other in a horizontal direction and a longitudinal direction in the same layer. The touch electrode of the present application is divided into a plurality of small touch sub-electrodes, which can significantly enhance the folding resistance of the touch electrode.

### FIELD OF INVENTION

The present application relates to the field of display technologies, and in particular, to a touch electrode, a touch panel, and a display device.

### BACKGROUND OF INVENTION

With the continuous development of display technologies, emerging foldable flexible display touch technology is just around the corner. Relevant industries are also accelerating the development of foldable touch technology with flexible displays. At present, the most common conductive material for touch screens is indium tin oxide (ITO). ITO was a material first adopted by the touch screen industry because of its good optical and electrical characteristics.

### Technical Problem

Indium tin oxide (ITO) is essentially an inorganic metal oxide material with significant brittleness. When used in a foldable touch screen, it is prone to crack due to long-term repetitive bending, thereby causing the touch function to fail.

### SUMMARY OF INVENTION

The present application provides a touch electrode, a touch panel, and a display device to solve the problem that the touch electrode is prone to crack due to long-term repeated bending in the prior art and resulting in the touch function fails.

To solve the above technical problem, the present application provides a touch electrode, the touch electrode includes: a plurality of first sub-electrodes and each two of the first sub-electrodes are electrically connected to each other by a connecting body; a plurality of second sub-electrodes and each two of the second sub-electrodes are directly electrically connected to each other; wherein the plurality of first sub-electrodes and the plurality of second sub-electrodes are staggered with each other in a horizontal direction and a longitudinal direction, and are disposed in the same layer.

To solve the above technical problem, the present application further provides a touch panel, the touch panel includes the above-mentioned touch electrodes.

To solve the above technical problem, the present application further provides a display device, the display device includes: a protective cover, a transparent optical adhesive, a touch layer, and a display screen, the touch layer includes the above-mentioned touch electrodes; wherein the protective cover, the transparent optical adhesive, the touch layer, and the display screen are sequentially stacked.

### Beneficial Effect

The present application proposes a touch electrode. The touch electrode includes a plurality of first sub-electrodes, wherein each two of the first sub-electrodes are electrically connected by a connecting body; and a plurality of second sub-electrodes, wherein each two of the second sub-electrodes are directly electrically connected. The plurality of first sub-electrodes and the plurality of second sub-electrodes are staggered with each other in a horizontal direction and a longitudinal direction in the same layer. The touch electrode of the present application is divided into a plurality of small touch sub-electrodes. The introduction of the touch sub-electrodes significantly enhances the folding resistance of the touch electrodes. In a long-term folding state, the touch sub-electrodes are independent of each other, which can effectively avoid the concentration of folding stress, prevent the generation and spread of cracks, and realize flexible foldable touch.

### DESCRIPTION OF FIGURES

In order to more clearly illustrate the technical solutions in the embodiments of the present invention, the following figures described in the embodiments will be briefly introduced. It is obvious that the figures described below are merely some embodiments of the present invention, other figures can also be obtained by the person ordinary skilled in the field based on these figures without doing any creative activity.

FIG. 1 is a schematic structural diagram of an embodiment of a touch electrode provided in the present application.

FIG. 2 is a schematic structural diagram of a first sub-electrode and/or a second sub-electrode provided in FIG. 1.

FIG. 3 is a schematic structural diagram of an embodiment of a first touch electrode provided in the present application.

FIG. 4 is a schematic structural diagram of an embodiment of a second touch electrode provided in the present application.

FIG. 5 is a schematic structural diagram of an embodiment of a touch panel provided in the present application.

FIG. 6 is a schematic structural diagram of an embodiment of a display device provided by the present application.

FIG. 7 is a schematic structural diagram of another embodiment of the display device provided by the present application.

FIG. 8 is a schematic structural diagram of a touch sub-electrode and a RGB light-emitting pixel provided in FIG. 7.

### DETAILED DESCRIPTION OF PREFERRED EMBODIMENTS

The technical solutions in the embodiments of the present application will be clearly and completely described below with reference to the accompanying figures in the embodiments of the present application. It can be understood that the specific embodiments described herein are only used to explain the present application, rather than limiting the present application. It should also be noted that, for convenience of description, the figures only show a part of the structure related to the present application, but not the entire structure. Based on the embodiments in the present application, all other embodiments obtained by a person of ordinary skill in the art without creative efforts shall fall within the protection scope of the present application.

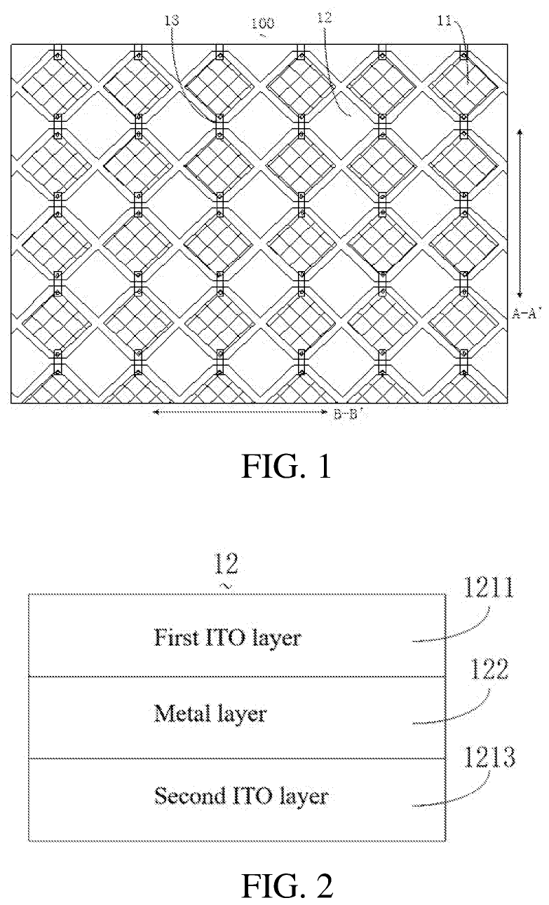

Please refer to FIG. 1. FIG. 1 is a schematic structural diagram of an embodiment of a touch electrode provided in the present application. The touch electrode 100 in FIG. 1 includes a plurality of first sub-electrodes 11 and a plurality of second sub-electrodes 12.

Wherein in the longitudinal direction of the touch electrode 100, i.e. direction A-A′ in the figure, each two of the plurality of first sub-electrodes 11 are electrically connected to each other by a connecting body 13 to form a path; and in the horizontal direction of the touch electrode 100, i.e. direction B-B′ in the figure, each two of the plurality of second sub-electrodes 12 are directly electrically connected to each other to form a path.

Further, an insulating medium (not shown in the figure) is provided between each first sub-electrode 11 and an adjacent second sub-electrode 12, and the insulating medium insulates the first sub-electrode 11 and the second sub-electrode 12.

Wherein the plurality of first sub-electrodes 11 and the plurality of second sub-electrodes 12 are staggered with each other in a horizontal direction and a longitudinal direction in the same layer. Specifically, as shown in FIG. 1, the first sub-electrode 11 and/or the second sub-electrode 12 has a rhombus structure.

The first sub-electrodes 11 is each provided with a first connection point 111 and a second connection point 112 in the longitudinal direction; each of the first sub-electrodes 11 is connected to an adjacent first sub-electrode 11 in the longitudinal direction by a connecting member 13, one end of the connecting member 13 is connected to a first sub-electrode 11 and a first connection point 111, and the other end of the connecting member 13 is connected to the second connection point 112 of the adjacent first sub-electrode 11.

The second sub-electrode 12 may be provided with a connection point (not shown in the figure) in the horizontal direction, and the connection point between adjacent second sub-electrodes 12 may be connected by an indium tin oxide (ITO) material so that a pathway is formed between the two second sub-electrodes 12. In other embodiments, each two of the second sub-electrodes 12 may also be in direct contact by the two corners of the rhombus structure in the longitudinal direction so that a path is formed between the two second sub-electrodes 12.

The contact points between the second sub-electrodes 12 or the connecting members 13 between the ITO material and the first sub-electrode 11 are not in contact with each other to prevent short circuiting.

Specifically, the connecting member 13 can be a metal bridge or other conductive structures for connecting electrodes.

Further, please refer to FIG. 2 together with FIG. 1. FIG. 2 is a schematic structural diagram of a first sub-electrode and/or a second sub-electrode provided in FIG. 1.

Taking the second sub-electrode 12 for an example, the second sub-electrode 12 specifically includes at least two ITO layers and a metal layer 122. The first ITO layer 1211, the metal layer 1212, and the second ITO layer 1213 are sequentially stacked to form a second sub-electrode 12.

In the present application, the first sub-electrode 11 and/or the second sub-electrode 12 is configured as a three-layer composite structure of ITO, a metal, and ITO, thereby improving the folding resistance of the first sub-electrode 11 and/or the second sub-electrode 12.

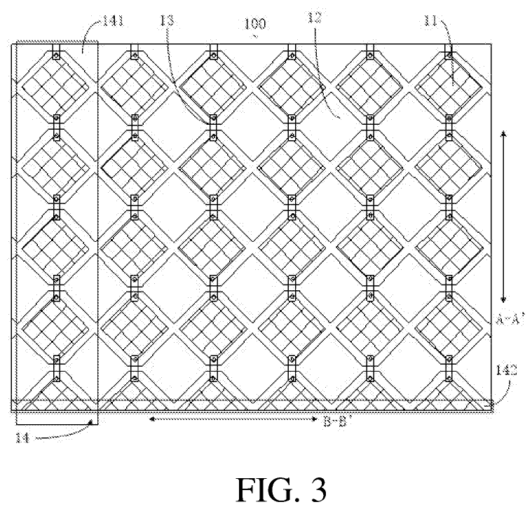

The metal layer can adopt silver material, and a thickness of the silver material is less than or equal to 15 nm. Furthermore, the touch electrode 100 can further include a first touch electrode 14 and a second touch electrode 15. Please refer to FIG. 3 together with FIG. 1. FIG. 3 is a schematic structural diagram of an embodiment of a first touch electrode provided in the present application.

The first touch electrode 14 includes a plurality of first electrode groups 141, and the plurality of first electrode groups 141 communicate with each other by a first metal lead 142. Each of the first electrode groups 141 is composed of the plurality of first sub-electrodes 11 in the longitudinal direction, and adjacent first sub-electrodes 11 are electrically connected by a metal bridge 13.

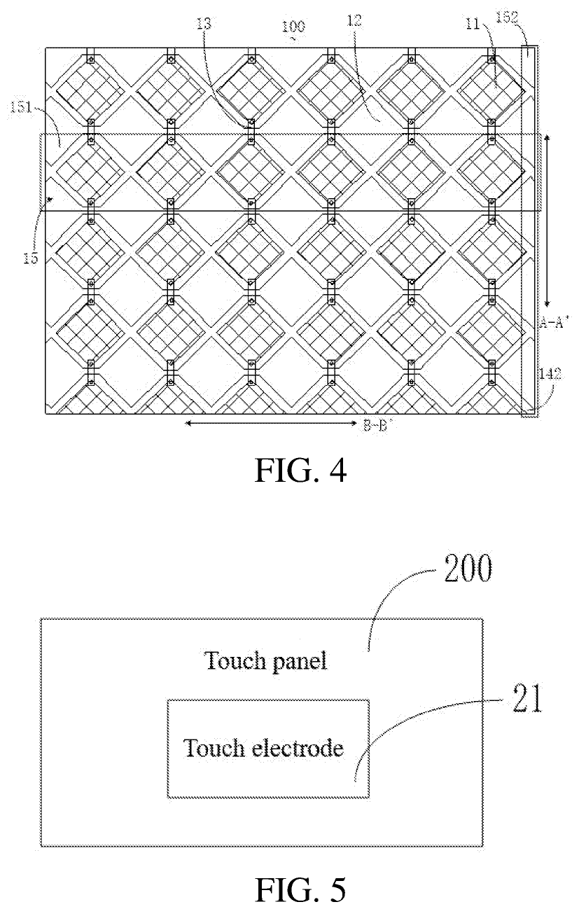

Please refer to FIG. 4 together with FIG. 1. FIG. 4 is a schematic structural diagram of an embodiment of a second touch electrode provided in the present application.

The second touch electrode 15 includes a plurality of second electrode groups 151, and the plurality of second electrode groups 151 communicate with each other by the second metal lead 152. Each of the second electrode groups 151 is composed of a plurality of second sub-electrodes 12 in the longitudinal direction, and adjacent second sub-electrodes 12 are directly electrically connected.

In the prior art, the minimum unit size of an ITO touch electrode is generally about 4 mm. However, the touch electrode 100 of the present application is divided into a plurality of first sub-electrodes 11 and a plurality of second sub-electrodes 12, and the size of each of the first sub-electrodes 11 and each of the second sub-electrodes 12 range from 50 to 800 μm. That is, the minimum unit size of the touch electrode 100 of the present application can be controlled between 50 and 800 μm. The present application proposes a concept of dividing the touch electrode 100 into small touch sub-electrodes. The introduction of the touch sub-electrode can significantly enhance the folding resistance of the touch electrode 100. In a long-term folding state, the touch sub-electrodes are independent of each other, which can effectively avoid the concentration of folding stress, prevent the generation and spread of cracks, and realize flexible foldable touch.

The present application also proposes a touch panel. Please refer to FIG. 5 for details. FIG. 5 is a schematic structural diagram of an embodiment of a touch panel provided by the present application.

The touch panel 200 of the present application includes the touch electrodes 21 in the above embodiments, and details are not described herein.

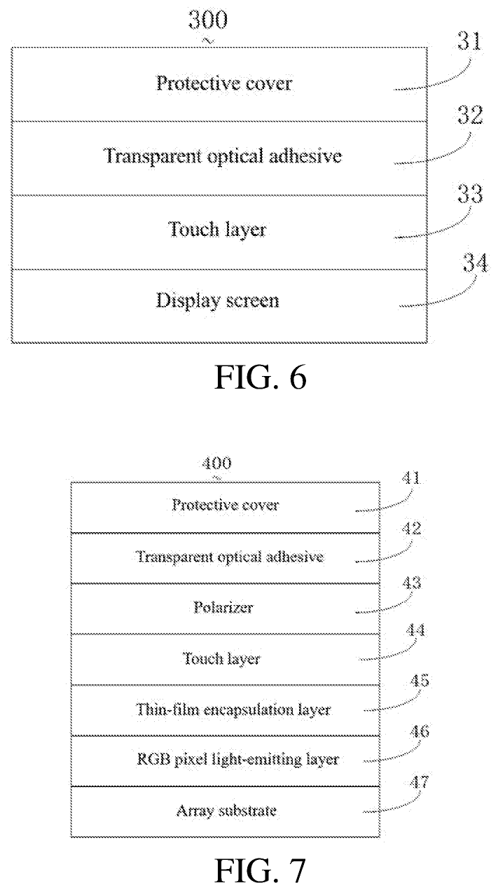

The present application also proposes a display device. For details, please refer to FIG. 6, which is a schematic structural diagram of an embodiment of a display device provided by the present application.

The display device 300 of the present application includes a protective cover 31, a transparent optical adhesive 32, a touch layer 33, and a display screen 34. The protective cover 31, the transparent optical adhesive 32, the touch layer 33, and the display screen 34 are sequentially stacked; and the touch layer 33 includes the touch electrodes (not shown in the figure) in the above embodiments, and details are not described herein again.

According to the above-mentioned embodiment of the touch electrode, the size of the touch sub-electrode is between 50 μm and 800 μm. In the present embodiment, the touch layer 33 is separately manufactured. The display device 300 adopts a transparent optical adhesive (OCA) bonding method to bond the touch layer 33 and the display screen 34 together, and a protective cover can also be bonded with the touch layer 33 by the OCA optical adhesive 32.

The display screen 34 can be an active-matrix organic light-emitting diode (AMOLED) display screen, or a liquid crystal display (LCD) or other technological type displays.

Further, please refer to FIG. 7 together with FIG. 6. FIG. 7 is a schematic structural diagram of another embodiment of a display device provided by the present application. In the display device 400 of the embodiment, a touch control layer is prepared above the organic light-emitting layer of the AMOLED display screen, and a thin-film encapsulation layer is used as a substrate for preparation.

The display device 400 includes a protective cover 41, a transparent optical adhesive 42, a polarizer 43, a touch layer 44, a thin-film encapsulation layer 45, a RGB pixel light-emitting layer 46, and an array substrate 47.

The above structures are sequentially stacked to form the display device 400 of the embodiment. Specifically, compared with the display device 300 of the above embodiment, a polarizer 43 is attached to the top of the touch layer 44, and a protective cover 41 is attached to the top of the polarizer 43 by a transparent optical adhesive 42.

Furthermore, the touch sub-electrodes of the touch layer 44 in the embodiment include a first sub-electrode and a second sub-electrode, which are arranged in one-to-one correspondence with the RGB pixel points of the RGB pixel light-emitting layer 46 so that the metal bridges between the plurality of first sub-electrodes are all positioned between the plurality of the pixel points. In this way, the metal bridges connecting to the first sub-electrodes are all positioned at the periphery of the RGB light-emitting region so as to prevent the pattern of the touch layer 44 from adversely affecting the display effect of the display screen.

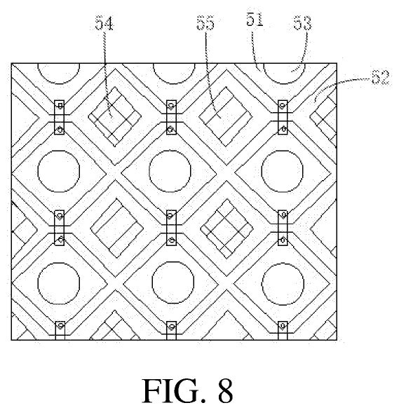

Please refer to FIG. 8. FIG. 8 is a schematic structural diagram of a touch sub-electrode and a RGB light-emitting pixel provided in FIG. 7.

As shown in FIG. 8, the first sub-electrode 51 is provided corresponding to the green light-emitting pixel 53 of the RGB pixel light-emitting layer 46. Each adjacent second sub-electrode 52 respectively corresponds to the red light-emitting pixel 54 and the blue light-emitting pixel 55 of the RGB pixel light-emitting layer 46.

Specifically, the metal bridge 56 connecting two adjacent first sub-electrodes 51 does not have an overlapping region in the vertical projection of the display device 400. That is, the metal bridge 56 is provided among the green light-emitting pixel 53, the red light-emitting pixel 54, and the blue light-emitting pixel 55.

The structures of the touch electrode, the touch panel, and the display device provided in the embodiments of the present application have been described in detail above. Specific examples are used herein to explain the principle and implementation of the present application. The description of the above embodiments is only used to understand the method of the present application and its core ideas. Meanwhile, for those of ordinary skill in the art, according to the idea of the present application, there will be modifications in the specific implementation and the scope of application. In summary, the content of the description should not be understood as a limitation on the present application.

What is claimed is:

1. A touch electrode, comprising:
a plurality of first sub-electrodes, wherein each two of the plurality of first sub-electrodes are electrically connected to each other by a connecting body;
a plurality of second sub-electrodes, wherein each two of the plurality of second sub-electrodes are directly electrically connected to each other;
wherein the plurality of first sub-electrodes and the plurality of second sub-electrodes are staggered with each other in a horizontal direction and a longitudinal direction in a same layer.

2. The touch electrode according to claim 1, wherein the first sub-electrode and/or the second sub-electrode is configured as a three-layer composite structure of indium tin oxide, a metal, and indium tin oxide, and the connecting body is a metal bridge.

3. The touch electrode according to claim 2, further comprising a first touch electrode and a second touch electrode, wherein the first touch electrode comprises a plurality of first electrode groups, the plurality of first electrode groups communicate by a first metal lead, and each of the first electrode groups is composed of the plurality of first sub-electrodes in the longitudinal direction and wherein the second touch electrode comprises a plurality of second electrode groups, the plurality of second electrode groups communicate by a second metal lead, and each of the second electrode groups is composed of the plurality of second sub-electrodes in the horizontal direction.

4. The touch electrode according to claim 2, wherein the first sub-electrodes and/or the second sub-electrodes has a rhombus structure; the first sub-electrodes is each provided with a first connection point and a second connection point in the longitudinal direction; each of the first sub-electrodes is connected to an adjacent first sub-electrode in the longitudinal direction by the metal bridge; and one end of the metal bridge is connected to the first connection point of the first sub-electrode, and the other end of the metal bridge is connected to the second connection point of an adjacent first sub-electrode.

5. The touch electrode according to claim 1, wherein an area of the first sub-electrode and/or the second sub-electrode ranges from 50 to 800 μm².

6. A touch panel comprising a touch electrode, wherein the touch electrode comprises:
a plurality of first sub-electrodes, wherein each two of the first sub-electrodes are electrically connected to each other by a connecting body;
a plurality of second sub-electrodes, wherein each two of the second sub-electrodes are directly electrically connected to each other;
wherein the plurality of the first sub-electrodes and the plurality of the second sub-electrodes are staggered with each other in a horizontal direction and a longitudinal direction in a same layer.

7. The touch panel according to claim 6, wherein the first sub-electrode and/or the second sub-electrode is configured as a three-layer composite structure of indium tin oxide, a metal, and indium tin oxide, and the connecting body is a metal bridge.

8. The touch panel according to claim 7, wherein the touch electrode further comprises a first touch electrode and a second touch electrode;
the first touch electrode comprises a plurality of first electrode groups, and the plurality of first electrode groups communicate by a first metal lead, wherein each of the first electrode groups is composed of the plurality of first sub-electrodes in the longitudinal direction; and
the second touch electrode comprises a plurality of second electrode groups, and the plurality of second electrode groups communicate by a second metal lead, wherein each of the second electrode groups is composed of the plurality of second sub-electrodes in the horizontal direction.

9. The touch panel according to claim 7, wherein the first sub-electrode and/or the second sub-electrode has a rhombus structure; the first sub-electrodes is each provided with a first connection point and a second connection point in the longitudinal direction; each of the first sub-electrodes is connected to an adjacent first sub-electrode in the longitudinal direction by the metal bridge; and one end of the metal bridge is connected to the first connection point of the first sub-electrode, and the other end of the metal bridge is connected to the second connection point of an adjacent first sub-electrode.

10. The touch panel according to claim 6, wherein an area of the first sub-electrode and/or the second sub-electrode ranges from 50 to 800 μm².

11. A display device, comprising:
a protective cover, a transparent optical adhesive, a touch layer, and a display screen, which are sequentially stacked, wherein the touch layer comprises touch electrodes and each of the touch electrodes comprises:
a plurality of first sub-electrodes, wherein each two of the first sub-electrodes are electrically connected to each other by a connecting body;
a plurality of second sub-electrodes, wherein each two of the second sub-electrodes are directly electrically connected to each other; wherein the plurality of first sub-electrodes and the plurality of second sub-electrodes are staggered with each other in a horizontal direction and a longitudinal direction in a same layer.

12. The display device according to claim 11, wherein a polarizer is further provided between the transparent optical adhesive and the touch layer, and a layer of the transparent optical adhesive is further provided between the touch layer and the display screen.

13. The display device according to claim 11, wherein the display screen further comprises a thin film encapsulation layer, a pixel light-emitting layer, and an array substrate, and wherein the thin film encapsulation layer, the pixel light-emitting layer, and the array substrate are sequentially stacked under the touch layer.

14. The display device according to claim 13, wherein the first sub-electrode and the second sub-electrode are arranged in one-to-one correspondence with pixel points of the pixel light-emitting layer so that metal bridges between the plurality of first sub-electrodes are all positioned between a plurality of the pixel points.

15. The display device according to claim 11, wherein the first sub-electrode and/or the second sub-electrode is configured as a three-layer composite structure of indium tin oxide, a metal, and indium tin oxide, and the connecting body is a metal bridge.

16. The display device according to claim 15, wherein the touch electrode further comprises a first touch electrode and a second touch electrode; the first touch electrode comprises a plurality of first electrode groups, and the plurality of first electrode groups communicate by a first metal lead, wherein each of the first electrode groups is composed of the plurality of first sub-electrodes in the longitudinal direction; and the second touch electrode comprises a plurality of second electrode groups, and the plurality of second electrode groups communicate by a second metal lead, wherein each of the second electrode groups is composed of the plurality of second sub-electrodes in the horizontal direction.

17. The display device according to claim 15, wherein the first sub-electrode and/or the second sub-electrode has a rhombus structure; the first sub-electrodes is each provided with a first connection point and a second connection point in a longitudinal direction; each of the first sub-electrodes is connected to an adjacent first sub-electrode in a longitudinal direction by the metal bridge; and one end of the metal bridge is connected to the first connection point of the first sub-electrode, and the other end of the metal bridge is connected to the second connection point of an adjacent first sub-electrode.

18. The display device according to claim 11, wherein an area of the first sub-electrode and/or the second sub-electrode ranges from 50 to 800 μm².
